(19) United States
(12) Patent Application Publication
(10) Pub. No.: US 2014/0179559 A1
(43) Pub. Date: Jun. 26, 2014

(54) COMPUTER-IMPLEMENTED METHOD FOR IDENTIFYING DIFFERENTIALLY EXPRESSED GENES AND COMPUTER READABLE STORAGE MEDIUM FOR STORING THE METHOD

(71) Applicant: National Central University, Taoyuan County (TW)

(72) Inventors: Chih-Hao CHEN, Kaohsiung City (TW); Hoong-Chien LEE, Taoyuan County (TW); Li-Jen SU, Taipei City (TW)

(21) Appl. No.: 13/923,386

(22) Filed: Jun. 21, 2013

(30) Foreign Application Priority Data
Dec. 21, 2012 (TW) 101149024

(51) Int. Cl. G06F 19/20

(52) U.S. Cl. CPC G06F 19/20
USPC 506/12

(57) ABSTRACT

A method for identifying differentially expressed genes including the following steps: measure gene expression levels of test samples and control samples; estimate variances of noise in the test samples and in the control samples; based on the measured expression levels and the estimated variances of noise, derive a probability density function (PDF) for predicting the true value of each expression level measurement; normalize the PDFs; based on the normalized PDFs of the gene under test, derive a test-group PDF for predicting the gene's mean expression level in the test samples and derive a control-group PDF for predicting the gene's mean expression level in the control samples; based on the test-group PDF and the control-group PDF of the gene under test, derive a final PDF for predicting the gene's fold-change; use the final PDF to test whether the gene is differentially expressed.

### RELATED APPLICATIONS

This application claims the priority benefit of Taiwan application serial no. 101149024, filed Dec. 21, 2012, the full disclosure of which is incorporated herein by reference.

### BACKGROUND

1. Technical Field

The present invention relates to a computer-implemented method for identifying differentially expressed genes (DEGs) and a computer-readable medium encoded with a computer program to execute the method.

2. Description of Related Art

Since DNA microarray was introduction in 1995, high-throughput gene expression profiling has emerged as one of the most important and powerful approaches in biomedical research. Its use to discover differentially expressed genes between replicated sample groups has found many applications. Although many studies reported success of application, often with high rates of validation using alternate technologies such as qRT-PCR or northern blot analysis, researchers were unsettled by the observed disparities between results obtained by different groups analyzing similar samples and called into question the validity of microarray assays. In a later study, by contrasting two commercially produced RNAs in technical quintuplicates, the MicroArray Quality Control (MAQC) Consortium showed distinct platforms and test sites performed comparably, generating similar lists of genes whose activity differed by at least a factor of two between the two RNA samples and owed the improved reproducibility over previous studies to its data analysis approach: while most researchers employed a statistical criterion foremost by applying a cutoff on the p-value from a t-test, the MAQC Consortium advised to loosen the p-value cutoff and add a fold-change cutoff because between platforms and test sites genes selected based on fold-change were found much more reproducible than those based on the t-test. Although the study has been criticized for implying that prioritizing genes by fold-change is more productive than by the level of statistical significance and employment of a fold-change cutoff leads to loss of statistical control, the approach, henceforth the MAQC method (MAQCm), has been widely practiced.

The t-test's apparent lack of statistical power results from its naive approach of variance estimation. For elucidation, we categorize data as either type I or type II and divide variance into two components, noise and non-noise. Type I data are made from samples of same DNA, such as biological replicates of a cell line; type II data are made from samples of different DNAs, such as clinically collected specimens; noise includes random noise and biological noise, is independent of differential expression and typically follows a normal distribution; non-noise, as explained below, exists only in type II data, arises from differential expression and hence shouldn't be included in the statistical testing. For the gene under test, if the variance of noise for each measurement were known so that the means and the fold-change could each be predicted using a Gaussian distribution function (Gaussian) as the probability density function, the z-test could in principle lead to the most reproducible gene-ranking among all possibilities. t-test ranking is same as z-test ranking with variance of noise taken as homogeneous among replicates and approximated as sample variance. Accuracy of the approximation is limited by sample size. For type II data, the approximation is rendered unjustifiable by molecular heterogeneity which manifests itself as expansion of sample variance with absolute fold-change. Although the expansion apparently exacts the to statistical testing be based on individually estimated variances, it arises from differential expression and, regardless of sample size, invalidates any method that mistakes the affected variances for noise and understates the genes' priority. Fold-change ranking, on the other hand, is same as z-test ranking with variance of noise taken as homogeneous among replicates and among genes. Its global superiority to t-test ranking implies either variance of noise is homogeneous among, genes or the differences between genes are trivial compared to effects of sample size limitations and molecular heterogeneity. In summary, the key to better statistical power for both types of data lies in an approach that excludes non-noise from the statistical testing, takes variance of noise as homogeneous among genes and estimates the common variance at full through-put capacity of the platform.

In light of the above insight, we have developed a method named Weighting Arrays By Error (WABE). WABE's design takes variance of noise as homogeneous among genes and, to handle samples of uneven quality, heterogeneous among replicates. By further assuming most genes are not differentially expressed and hence not affected by non-noise, WABE estimates the sample-wise variances of noise based on data of all genes. We schematically illustrate WABE in FIG. 1, detail its procedure in DETAILED DESCRIPTION and list its distinctive features below: (i) WABE estimates a sample-wise variance of noise based on fluctuation of log-transformed intensity ratios among genes, obtained by pair-wisely comparing the sample to other samples of the group; accuracy of the estimation is ensured by the platform's throughput capacity, is not limited by sample size, has no dependence on normalization and is much higher than that of the t-test; (ii) the accuracy allows the testing for a gene be conducted as a z-test; (iii) WABE relies solely on the z-test p-value for selecting differentially expressed genes and hence provides complete statistical control; (iv) the sample-wise variances of noise facilitate weighting of samples which further optimizes gene-ranking.

### SUMMARY

As an embodiment of this invention, a computer-implemented method for identifying DEGs is provided. The method, named WABE, comprises the following steps:

(a) Obtain gene expression data from several test samples and several control samples.

(b) Estimate variance of noise in each sample.)

(c) For each expression measurement, use a Gaussian distribution function (Gaussian), which takes the measured value as mean and the sample's variance of noise as variance, as probability density function (PDF) for predicting its true value.

(d) Normalize the Gaussians.

(e) For each gene, based on the normalized Gaussians for the test samples, derive the test-group Gaussian for predicting mean expression level of the test group; based on the normalized Gaussians for the control samples, derive the control-group Gaussian for predicting mean expression level of the control group.

(f) Based on the test-group Gaussian and the control-group Gaussian, derive the final Gaussian for predicting fold-change of the gene.

(g) Based on the final Gaussian, conduct a z-test to determine whether the gene is differentially expressed.

As another embodiment of this invention, a computer-readable storage medium storing a computer program for executing the steps of the aforementioned method is provided. Steps of the method are as disclosed above.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of WABE;

FIGS. 2A-2E show an application of WABE; and

FIGS. 3A and 3B compare WABE to MAQCm in intra-set reproducibility using 329 data contrasts.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

As an embodiment of the present invention, a z-test based method for identifying DEGs is provided. The method, named WABE, differs from t-test based methods in that the non-noise component of variance is excluded from the statistical testing and that variance of noise is taken as homogeneous among genes but heterogeneous among replicates. Accordingly, the statistical testing is based on sample-wise variances of noise derived from data of all genes rather than based on gene-wise variances derived from data of the gene under test. The method may take the form of a computer program product stored on a non-transitory computer-readable storage medium having computer-readable instructions embodied in the medium. Any suitable non-transitory storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

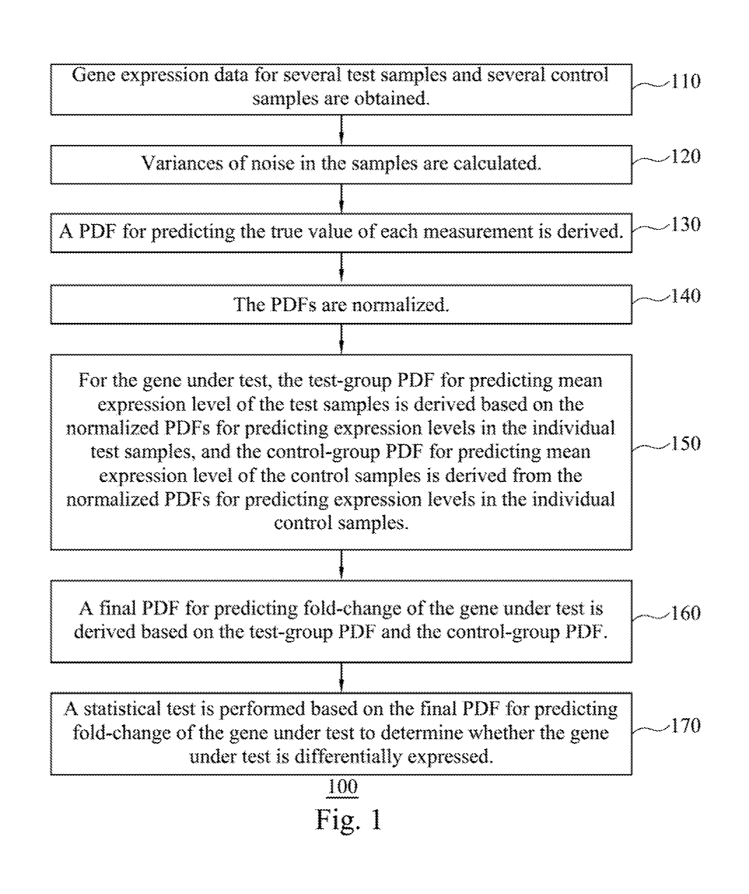

FIG. 1 is a flow diagram for WABE. Step 100 for identifying DEGs comprises the following, steps:

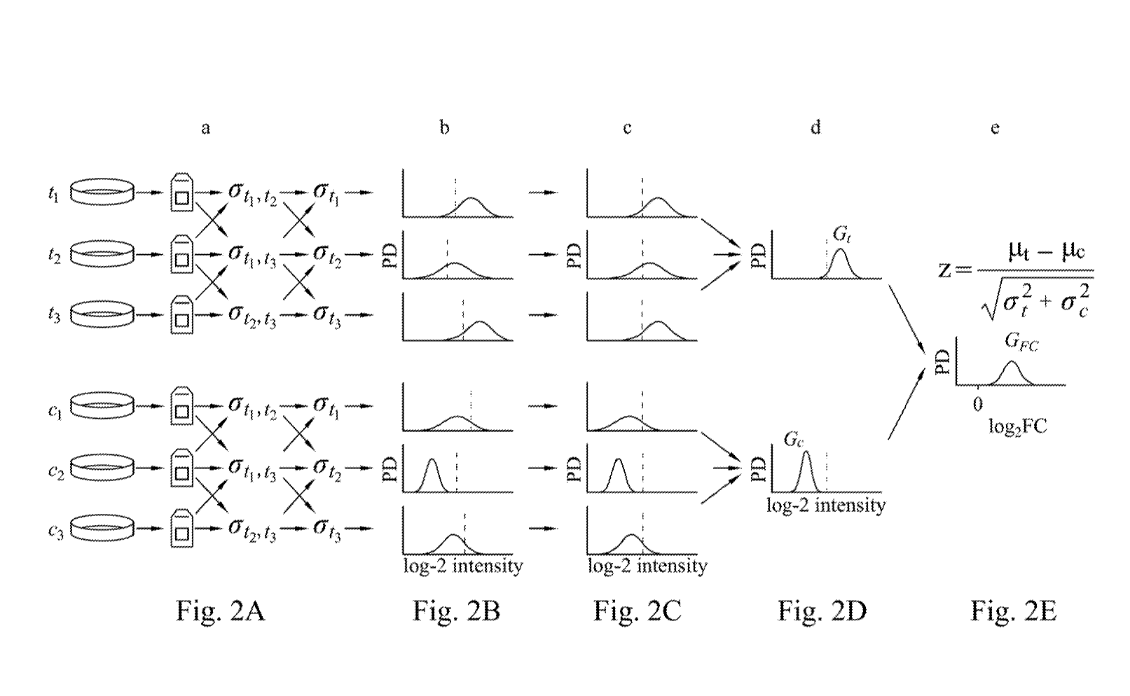

At step 110, gene expression data for several test samples and several control samples are obtained. FIG. 2A is an example of step 110. In the example, the three test samples are designated as t₁, t₂ and t₃, and the three control samples are designated as c₁, c₂ and c₃. The gene expression data are the log-transformed fluorescence intensities obtained via DNA microarrays. In another embodiment of this invention, the gene expression data can be log-transformed sequence reads from a next-generation sequencer.

At step 120, variances of noise in the samples are calculated. FIG. 2A is an embodiment of step 120. In the embodiment, the variance of noise in tᵢ is estimated using σₜ_{ᵢ}²=2⁻¹(nₜ−1)⁻¹Σ_{j≠i}σₜ_{ᵢ}_{,t}_{ⱼ}², wherein nₜ is number of the test samples and σₜ_{ᵢ}_{,t}_{ⱼ}² is the estimated distribution variance of log-transformed intensity ratios between tᵢ and tⱼ. Similarly, the variance of noise in cᵢ is estimated using σ_{c}_{ᵢ}²=2⁻¹(n_{c}−1)⁻¹Σ_{j≠i}σ_{c}_{ᵢ}_{,c}_{ⱼ}², wherein n_{c} is number of the control samples and σ_{c}_{ᵢ}_{,c}ⱼ² is the estimated distribution variance of log-transformed intensity ratios between cᵢ and cⱼ.

At step 130, a PDF for predicting the true value of each measurement is derived. FIG. 2B is an embodiment of step 130. In the embodiment, where a gene is being tested for differential expression, the PDF is a Gaussian taking the measured value as mean and the sample's variance of noise as variance. More specifically, the PDF is G(y;μ,σ²)=(σ\sqrt{2π})⁻¹exp(−(y−μ)²/2σ²), wherein y is the variable, μ is the measured value and σ² is the sample's variance of noise.

At step 140, the PDFs are normalized. FIG. 2C is an embodiment of step 140. In the embodiment, scaling normalization is performed on the Gaussians so that array averages of expression measurements, which are shown with the dashed lines, are aligned.

At step 150, for the gene under test. the test-group PDF for predicting mean expression level of the test samples is derived based on the normalized PDFs for predicting expression levels in the individual test samples, and the control-group PDF for predicting mean expression level of the control samples is derived from the normalized PDFs for predicting expression levels in the individual control samples. The flow from FIG. 2C to FIG. 2D is an embodiment of step 150. In the embodiment, the test-group PDF Gₜ=G(y;μₜ,σₜ²) is derived using σₜ⁻²=σₜ_{₁}⁻²+σₜ_{₂}⁻²+σₜ_{₃}⁻² and μₜσₜ⁻²=μₜ_{₁}σₜ_{₁}⁻²+μₜ_{₂}σₜ_{₂}⁻²+μₜ_{₃}σₜ_{₃}⁻², wherein μₜ_{₁}, μₜ_{₂} and μₜ_{₃} are the expression levels and σₜ_{₁}⁻², σₜ_{₂}⁻² and σₜ_{₃}⁻² are the variances of noise in the respective test samples. The control-group PDF G_{c}=G(y;μ_{c},σ_{c}²) is derived similarly.

At step 160, a final PDF for predicting fold-change of the gene under test is derived based on the test-group PDF and the control-group PDF. The flow from FIG. 2D to FIG. 2E is an embodiment of step 160. In the embodiment, the final PDF G_{FC} is derived based on the test-group PDF Gₜ and the control-group PDF G_{c} using G_{FC}=G(y;μₜ−μ_{c},σₜ²+σ_{c}²).

At step 170, a statistical test is performed based on the final PDF for predicting fold-change of the gene under test to determine whether the gene under test is differentially expressed. FIG. 2E is an embodiment of step 170, In the embodiment, because the final PDF G_{FC} for predicting fold-change of the gene under test is a Gaussian, the statistical test can be conducted as a z-test with z=(μₜ−μ_{c})/\sqrt{σₜ²+σ_{c}².}

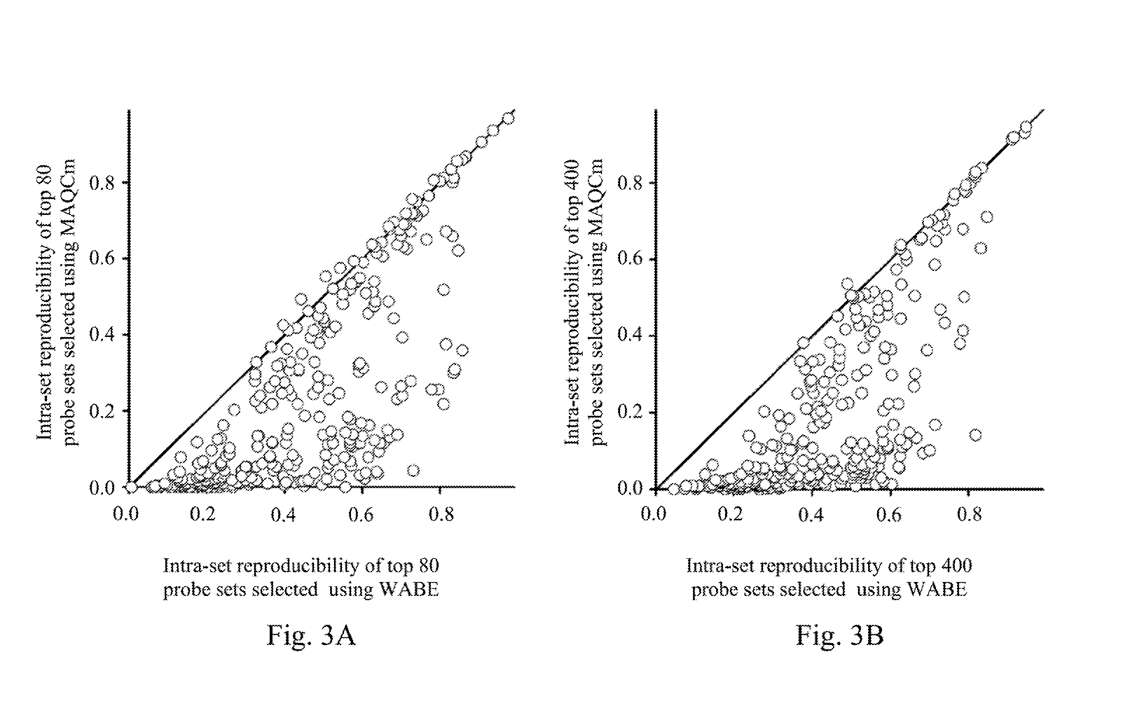

FIG. 3A and FIG. 3B compare WABE to MAQCm in Intra-set reproducibility using 329 data contrasts. Intra-set reproducibility is calculated as follows. Divide each data contrast into halves in four different ways. For each way, the same number of differentially expressed genes are selected from each half and the rate of overlapping genes is calculated. Intra-set reproducibility is defined as the average rate of overlapping genes over the four ways of division. In FIG. 3A top 80 genes are selected, while in FIG. 3B top 400 genes are selected. WABE is shown to have higher Intra-set reproducibility in both cases.

Although the present invention has been described in considerable detail with reference to certain embodiments thereof, other embodiments are possible. Therefore, the spirit and scope of the appended claims should not be limited to the description of the embodiments contained herein. It will be apparent to those killed in the art that various modifications and variations can be made to to the structure of the present invention without departing from the scope or spirit of the invention. In view of the foregoing, it is intended that the present invention cover modifications and variations of this invention provided they fall within the scope of the following claims.

What is claimed is:

1. A computer-implemented method for identifying differentially expressed genes (DEGs) comprising:
(a) obtaining gene expression data from a plurality of test samples and a plurality of control samples;
(b) estimating variances of noise in the test samples based on their gene expression data, and estimating variances of noise in the control samples based on their gene expression data;
(c) for each measurement of gene expression level, based on the measured value and the sample's variance of noise, deriving a probability density function (PDF) for predicting the true value;
(d) normalizing the PDFs for predicting gene expression levels;
(e) for the gene under test, based on the normalized PDFs for predicting the expression levels in the individual test samples deriving a test-group PDF for predicting mean expression level of the test samples, and, based on the normalized PDFs for predicting the expression levels in the individual control samples, deriving a control-group PDF for predicting mean expression level of the control samples;
(f) for the gene under test, based on the test-group PDF for predicting mean expression level of the test samples and the control-group PDF for predicting mean expression level of the control samples, deriving a final PDF for predicting fold-change of the gene; and
(g) for the gene under test, conducting a statistical test based on the final PDF for predicting fold-change of the gene to determine whether the gene is differentially expressed.

2. The method for identifying DEGs of claim 1, wherein step (a) comprises:
taking as the gene expression data log-transformed fluorescent intensities measured from the test samples and the control samples using DNA microarrays.

3. The method for identifying DEGs of claim 1, wherein step (a) comprises:
taking as the gene expression data log-transformed sequence read from the test samples and the control samples using a next-generation sequencer.

4. The method for identifying DEGs of claim 1, wherein step (b) comprises:
using σₜ_{ᵢ}²=2⁻¹(nₜ−1)⁻¹Σ_{j≠i}σₜ_{ᵢ}_{,t}_{ⱼ}², wherein nₜ is number of the test samples and σₜ_{ᵢ}_{,t}_{ⱼ}² is the estimated distribution variance of log-transformed intensity ratios between tᵢ and tⱼ, to estimate variance of noise σₜ_{ᵢ}² in test sample tᵢ; and using σ_{c}_{ᵢ}²=2⁻¹(n_{c}−1)⁻¹Σ_{j≠i}σ_{c}_{ᵢ}_{,c}_{ⱼ}², wherein n_{c} is number of the control samples and σ_{c}_{ᵢ}_{,c}_{ⱼ}² is the estimated distribution variance of log-transformed intensity ratios between cᵢ and cⱼ, to estimate variance of noise σ_{c}_{ᵢ}² in control sample cᵢ.

5. The method for identifying DEGs of claim 1, wherein step (c) comprises:
taking the Gaussian distribution function G(y;μ,σ²)=(σ\sqrt{2π})⁻¹exp(−y−μ)²/2σ²), wherein y is the variable, μ is the measured expression level and σ² is the sample's variance of noise, as the PDF for predicting true value of the measurement.

6. The method for identifying DEGs of claim 1, wherein step (d) comprises:
using scaling normalization to normalize the PDFs so that the average expression levels of the samples are aligned.

7. The method for identifying DEGs of claim 1, wherein step (e) comprises:
using Gₜ=G(y;μₜ,σₜ²)∝πᵢG(y;μₜ_{ᵢ},σₜ_{ᵢ}²), wherein G(y;μₜ_{ᵢ},σₜ_{ᵢ}²) is the normalized PDF for predicting expression level of the gene under test in test sample tᵢ, σₜ⁻²=Σᵢσₜ_{ᵢ}⁻² and μₜσₜ⁻²=Σᵢμₜ_{ᵢ}σₜ_{ᵢ}⁻², as the test-group PDF for predicting the average expression level of the gene under test in the test samples; and
using G_{c}=G(y;μ_{c},σ_{c}²)∝πᵢG(y;μ_{c}_{ᵢ},σ_{c}_{ᵢ}²), wherein G(y;μ_{c}_{ᵢ},σ_{c}_{ᵢ}²) is the normalized PDF for predicting expression level of the gene under test in control sample cᵢ, σ_{c}⁻²=Σᵢσ_{c}_{ᵢ}⁻² and μ_{cσ}_{c}⁻²=Σᵢμ_{c}_{ᵢ}σ_{c}_{ᵢ}⁻², as the control-group PDF for predicting the average expression level of the gene under test in the test samples.

8. The method for identifying DEGs of claim 1, wherein step (f) comprises:
using G_{FC}=G(y;μₜ−μ_{c},σₜ²+σ_{c}²) to convert the test-group PDF Gₜ=G(y;μₜ,σₜ²) and the control-group PDF G_{c}=G(y;μ_{c},σ_{c}²) into the final PDF G_{FC} for predicting fold-change of the gene under test.

9. The method for identifying DEGs of claim 1, wherein step (g) comprises:
conducting a z-test with z=(μₜ−μ_{c})/\sqrt{σₜ²+σ_{c}²} to determine whether the gene under test is differentially expressed.

10. A computer-readable medium encoded with a computer program to execute a method for identifying DEGs, wherein the method for identifying DEGs comprises:
(a) obtaining gene expression data from a plurality of test samples and a plurality of control samples;
(b) estimating variances of noise in the test samples based on their gene expression data, and estimating variances of noise in the control samples based on their gene expression data;
(c) for each measurement of gene expression level, based on the measured value and the sample's variance of noise, deriving a probability density function (PDF) for predicting the true value;
(d) normalizing the PDFs for predicting gene expression levels;
(e) for the gene under test, based on the normalized PDFs for predicting the expression levels in the individual test samples, deriving a test-group PDF for predicting mean expression level of the test samples, and, based on the normalized PDFs for predicting the expression levels in the individual control samples, deriving a control-group PDF for predicting mean expression level of the control samples;
(f) for the gene under test, based on the test-group PDF for predicting mean expression level of the test samples and the control-group PDF for predicting mean expression level of the control samples, deriving a final PDF for predicting fold-change of the gene; and
(g) for the gene under test, conducting a statistical test based on the final PDF for predicting fold-change of the gene to determine whether the gene is differentially expressed.
